(19) United States
(12) Patent Application Publication
(10) Pub. No.: US 2020/0065752 A1
(43) Pub. Date: Feb. 27, 2020

(54) INFORMATION PROCESSING METHOD, INFORMATION PROCESSING DEVICE, RECORDING MEDIUM ON WHICH A PROGRAM IS RECORDED, AND COMMUNICATION SYSTEM

(71) Applicant: LINE CORPORATION, Tokyo (JP)

(72) Inventors: Kazuki MATSUDA, Tokyo (JP); Shouji Fujiwara, Tokyo (JP); Masaki Kunikyo, Tokyo (JP); Chizuru Oeda, Tokyo (JP)

(73) Assignee: LINE CORPORATION, Tokyo (JP)

(21) Appl. No.: 16/670,595

(22) Filed: Oct. 31, 2019

Related U.S. Application Data
(63) Continuation of application No. PCT/JP2018/007535, filed on Feb. 28, 2018.

(30) Foreign Application Priority Data
Jun. 7, 2017 (JP) 2017-112875

(51) Int. Cl. G06Q 10/08; G06F 21/60; G06Q 20/12; G06Q 10/02; G06Q 10/10

(52) U.S. Cl. CPC G06Q 10/087; G06F 21/606; G06K 19/06046; G06Q 10/02; G06Q 10/10; G06Q 20/1235

(57) ABSTRACT

An information processing device may be configured to perform: assigning a number to a barcode of a predetermined standard for product management to a user of a terminal, including information for identifying a business operator supplying a product and information for identifying the product; storing the user identification information and the assigned number in association with each other; transmitting the assigned number to the terminal; receiving transaction data including numbers of barcodes read from a barcode reader; and converting a number of a barcode of the numbers of barcodes included in the transaction data into the user identification information based on the stored information.

### CROSS-REFERENCE TO RELATED APPLICATIONS

This application is a continuation of International Patent Application No. PCT/JP2018/007535 filed on Feb. 28, 2018, which claims priority from Japanese Patent Application No. 2017-112875, filed on Jun. 7, 2017, in the Japanese Patent Office, the disclosures of which are incorporated herein by reference in their entireties.

### BACKGROUND

### 1. Field

Apparatuses, methods, and systems consistent with example embodiments relate to an information processing method, information processing device, recording medium on which a program is recorded, and communication system.

### 2. Description of Related Art

In the related art, systems may use a terminal (e.g., a smartphone) as a substitute for a points card that can be presented at retail stores of a certain company. In such systems, an application provided from a certain company may be installed on a terminal, and a barcode for each user uniquely issued by the company may be displayed on the terminal through the application. Furthermore, the barcode may be scanned and read by a barcode reader at a brick and mortar retail store of the company, and thereby, a reward such as points or the like is provided to a user corresponding to the barcode. A unique barcode system used only within the certain company is used for the barcode.

However, in the related art systems, managing barcode numbers for a number of customers (users)in a manner distinguishable from barcode numbers for products in a Point of Sales (POS) system of a plurality of affiliated companies may be burdensome and complex if each customer uses an unique barcode displayed on his/her terminal at physical offline stores of a plurality of companies.

### SUMMARY

Example embodiments address at least the above problems and/or disadvantages and other disadvantages not described above. Also, the example embodiments are not required to overcome the disadvantages described above, and may not overcome any of the problems described above.

One or more example embodiments provide an information processing method, an information processing device, and a program that can relatively easily acquire information of a user performing a transaction at a physical offline store.

According to an aspect of an example embodiment, there is provided an information processing method including: assigning a barcode to a user of a terminal, the barcode including information for identifying a business operator supplying a product and information for identifying the product; storing user identification information of the user and the assigned barcode in association with each other; transmitting the assigned barcode to the terminal; receiving transaction data including a plurality of barcodes that are read by a barcode reader; and converting one of the plurality of barcodes included in the transaction data into the user identification information based on the stored assigned barcode.

The assigned barcode may comply with a predetermined standard for product management. The predetermined standard may be a Japanese Article Number (JAN) code, an European Article Number (EAN) code, or a Universal Product Code (UPC) code.

The receiving may include: receiving, from a point of sales (POS) system reading one of the plurality of barcodes that is displayed on the terminal, the transaction data indicating that a unit price of the product corresponding to the assigned barcode is calculated to be zero, based on the assigned barcode.

The information processing method may further include providing a predetermined reward based on at least one of a transacted amount, a transacted store, and a transacted business operator included in the transaction data to the user.

The assigning may include assigning the barcode to the user only for a predetermined period of time; the storing may include storing the user identification information, the assigned barcode, and the predetermined period of time in association with each other; the receiving may include receiving the transaction data indicating information of a transacted product and a transacted date and time; and the converting may include converting the one of the plurality of barcodes indicating the transacted product, into the user identification information, based on the stored assigned barcode.

The assigning may further include determining the predetermined period of time based on a barcode assignment frequency.

According to an aspect of another example embodiment, there is provided an information processing device, including: a storage configured to store instructions; and a processor configured to execute the instructions to: assign a barcode to a user of a terminal, the barcode including information for identifying a business operator supplying product and information for identifying the product; store user identification information of the user and the assigned barcode in association with each other; transmit the assigned barcode to the terminal; receive transaction data including a plurality of barcodes that are read by a barcode reader; and convert one of the plurality of barcodes included in the transaction data into the user identification information based on the stored assigned barcode.

The assigned barcode may comply with a predetermined standard for product management. The predetermined standard may be a Japanese Article Number (JAN) code, an European Article Number (EAN) code, or a Universal Product Code (UPC) code.

The processor may be further configured to execute the instructions to: receive, from a POS system reading the one of the plurality of barcodes that is displayed on the terminal, the transaction data indicating that a unit price of the product corresponding to the assigned barcode is calculated to be zero, based on the assigned barcode

The processor may be further configured to execute the instructions to: provide a predetermined reward based on at least one of a transacted amount, a transacted store, and a transacted business operator included in the transaction data to the user.

The processor may be further configured to execute the instructions to: set an effective period of time for the assign barcode; and cause the assigned barcode to expire after the effective period of time.

The processor may be further configured to execute the instructions to: set the effective period of time based on a barcode assignment frequency.

According to an aspect of another example embodiment, there is provided a non-transitory computer-readable storage medium storing a program that is executable by a computer to perform the information processing method.

According to an aspect of another example embodiment, there is provided a communication system including an information processing device, a terminal and a POS system, wherein the information processing device may include: a storage configured to store instructions; and a processor configured to execute the instructions to: assign a barcode to a user of a terminal, the barcode including information for identifying a business operator supplying product and information for identifying the product; store user identification information of the user and the assigned barcode in associated with each other; transmit the assigned number to the terminal; receive transaction data including a plurality of barcodes that are read by a barcode reader; and convert one of the plurality of barcodes included in the transaction data into the user identification information based on the stored assigned barcode; wherein the terminal configured to display the one of the plurality of barcodes that corresponds to the assigned barcode that is assigned by the information processing device; and wherein the POS system configured to read the one of the plurality of barcodes that is displayed on the terminal and barcodes of each product using the barcode reader, and transmit the transaction data including the read one of the plurality of barcodes and the barcodes of each product to the information processing device.

### BRIEF DESCRIPTION OF THE DRAWINGS

The above and/or other aspects will be more apparent by describing certain example embodiments, with reference to the accompanying drawings, in which:

FIG. 1 is a diagram illustrating a configuration of a communication system according to an example embodiment;

FIG. 2 is a diagram showing an example of a processing sequence of the communication system according to an example embodiment;

FIG. 3 is a diagram showing an example of barcode management data according to an example embodiment;

FIG. 4 is a diagram showing an example of user management data according to an example embodiment;

FIG. 5 is a diagram illustrating an example of a display screen of a barcode and effective period on a terminal according to an example embodiment;

FIG. 6 is a diagram illustrating an example of a barcode displayed on the terminal according to an example embodiment;

FIG. 7 is a diagram showing an example of product management data according to an example embodiment;

FIG. 8 is a diagram illustrating an example of a receipt according to an example embodiment;

FIG. 9 is a diagram showing an example of sales management data according to embodiments;

FIG. 10 is a diagram illustrating an example of a condition based on timings of a barcode number and the like; and

FIG. 11 is a diagram showing an example of rewards data according to an example embodiment.

### DETAILED DESCRIPTION

Compliance with Confidentiality of Communications

It should be noted that the disclosure described in the present specification is implemented in compliance with legal matters related to the confidentiality of communications.

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

According to example embodiments, methods and apparatuses of assigning a barcode that can identify a user who has performed a transaction at a physical store will be described with reference to the drawings.

### System Configuration

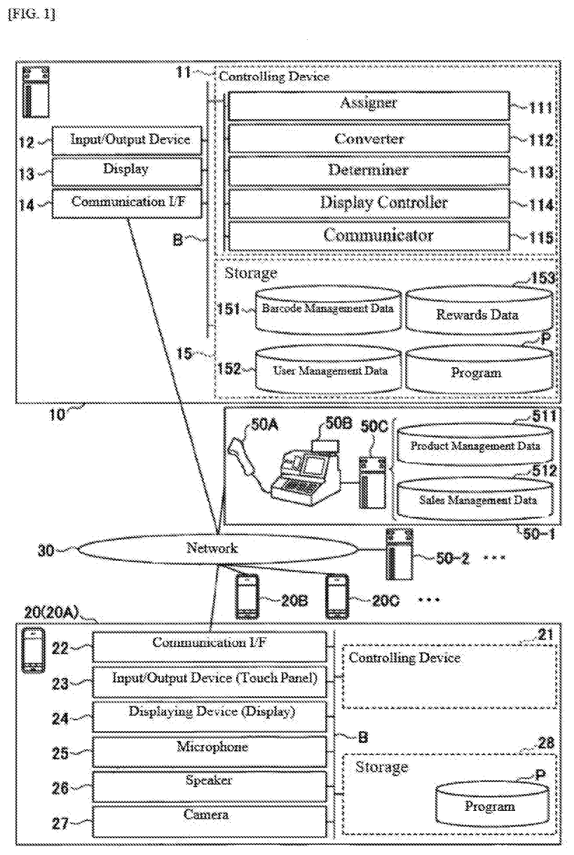

FIG. 1 is a diagram illustrating a configuration of a communication system 1 according to an example embodiment. As illustrated in FIG. 1, the communication system 1 may include a server 10, terminals 20, and Point of Sales (POS) systems 50-1, 50-2, . . . (hereinafter, simply referred to as “POS system 50” if there is not need to distinguish therebetween). The terminals 20 may include a terminal 20A, a terminal 20B, and a terminal 20C. The server 10, the terminals 20, and the POS system 50 are connected through a network 30. The POS system 50 may be an example of an “external system”. The server 10 provides a service for transmitting and receiving a message between the terminals 20, through the network 30. FIG. 1 illustrates three terminals 20, but the number of terminals 20 connected to the network 30 is not limited thereto.

The network 30 may connect one or more terminals 20 to one or more servers 10. The network 30 may be a communication network that provides a connection path such that data can be transmitted and received once the terminal 20 is connected to the server 10.

For example, one or a plurality of portions of the network 30 may be a wired network or a wireless network. Examples of the network 30 may include ad hoc networks, intranets, extranets, virtual private networks (VPN), local area networks (LAN), wireless LANs (WLAN), wide area networks (WAN), wireless WANs (WWAN), metropolitan area networks (MAN), portions of the Internet, portions of public switched telephone networks (PSTN), mobile telephone networks, integrated service digital networks (ISDNs), wireless LANS, long term evolution (LTE) code division multiple access (CDMA) networks, Bluetooth (registered trademark) communications, satellite communications, and the like, and a combination of two or more thereof. However, in the present disclosure, the network 30 is not limited thereto. Furthermore, the network 30 may include one or a plurality of networks 30.

The terminals 20 (e.g., terminal 20A, terminal 20B, terminal 20C) may be any terminal so long as the terminals are information processing terminals that can implement a function described in the example embodiments. The terminal 20 is typically a smartphone, but also include mobile telephones (e.g., feature phones), computers (e.g., desktops, laptops, tablets, and the like), media computer platforms (e.g., cables, satellite set-top boxes, and digital video recorders), handheld computer devices (e.g., personal digital assistant (PDA), email clients, and the like), wearable terminals (e.g., glasses-type devices, watch-type devices, and the like), as well as other types of computers and communication platforms. However, in the present disclosure, the terminal 20 is not limited thereto. Furthermore, the terminal 20 may be referred to as an information processing terminal.

Configurations of the terminal 20A, terminal 20B, and terminal 20C may be substantially the same, and therefore, in the following description, the terminal 20 will be described as a representative. For convenience of description, user information corresponding to a terminal 20X is referred to as user information X, and a user operating the terminal 20X is referred to as user X. User information may contain a portion or all information corresponding to a social networking service (SNS) account that represents an instant messenger. Examples of the user information may include any one or any combination of a user name, user image, a user identifier, a user's age, sex, and address. However, the examples of the user information are not limited thereto.

The server 10 is configured to provide a predetermined service to the terminal 20. For example, the server 10 may provide a social networking service (SNS) and may provide a service of distributing advertising information of a campaign or promotion in a physical store of an associated business operator, a service of applying a point based on a purchase amount or the like in the physical store, and the like.

The server 10 may be any device so long as the device is an information processing device that can implement a function described in the example embodiments. Examples of server 10 include a smartphone, computers (e.g., desktops, laptops, tablets, and the like), media computer platforms (e.g., cables, satellite set-top boxes, and digital video recorders), handheld computer devices (e.g., PDAs, email clients, and the like), as well as other types of computers and communication platforms. However, in the present disclosure, the server 10 is not limited thereto. Furthermore, the server 10 may be referred to as an information processing device.

The POS system 50 is a POS system that is operated by a business operator that is associated with a business operator (company) operating the server 10 for example. The POS system 50 may include a barcode reader 50A, a register (e.g., POS register, cash register) 50B, an office server 50C, and the like. The barcode reader 50A reads a barcode attached to a package of a product or the like. The register 50B acquires a unit price of a product based on the barcode read by the barcode reader 50A from product management data 511 stored in the office server 50C, calculates a total amount of transactions (sales) of one or more products, issues a receipt where transaction contents are printed, and then stores the transaction contents in sales management data 512 of the office server 50C. The office server 50C notifies the server 10 of transaction contents related to the server 10 of the transaction contents stored in the sales management data 512.

The server 10 may be operated by a business operator (e.g., a service provider) that provides a service such as an SNS or the like for example. The POS system 50 may be operated by a business operator that sells clothing, food, cosmetics, and other products and services.

### Hardware (HW) Configuration

A hardware configuration of devices which is included in the communication system 1 will be described with reference to FIG. 1.

### (1) HW Configuration of Terminal

The terminal 20 is provided with a controlling device 21, a storage 29, a communication interface (I/F) 22, an input/output device 23, a displaying device 24, a microphone 25, a speaker 26, and a camera 27. The control device 21 may be implemented as at least one central processing unit (CPU), or at least one processor. Components of the terminal 20 are mutually connected through a bus B for example.

The communication I/F 22 transmits and receives various data through the network 30. The communication may be performed either by wire or wirelessly, and any communication protocol may be used so long as mutual communication can be performed. The communication I/F 22 may establish a connection between the terminal 20 and the server 10, and may perform communication with the server 10 through the network 30. The communication I/F 22 transmits various data to the server 10 based on instruction from the controlling device 21. Furthermore, the communication I/F 22 receives various data transmitted from the server 10 and then transmits to the controlling device 21.

The input/output device 23 includes a device that inputs various operations with regard to the terminal 20 and a device that outputs processing results processed in the terminal 20. For the input/output device 23, an inputting device and outputting device may be integrated or separated.

The inputting device is implemented by any one or a combination from all types of devices that can receiving an input from a user and then transmit information related to the input to the controlling device 21. The inputting device may be implemented by a touch panel or the like, which detects contact of a user's finger or an indicating tool such as a stylus or the like and a contact position thereof, and transmits a coordinate of the contact position to the controlling device 21. On the other hand, the inputting device may be implemented by an inputting device other than a touch panel. The inputting device includes a hardware key represented by a keyboard or the like, a pointing device such as a mouse or the like, camera (operation input via a moving image), and microphone (operation input based on audio). However, in the present disclosure, the inputting device is not limited thereto.

The outputting device is implemented by any one or a combination from all types of devices that can output processing results processed in the controlling device 21. The outputting device may be implemented by a touch panel or the like. On the other hand, the outputting device may be implemented by an outputting device other than a touch panel. For example, a speaker (audio output), lens (such as three dimensional (3D) output or hologram output), printer, and the like can be included. However, in the present disclosure, the outputting device is not limited thereto.

The displaying device 24 is implemented by any one or a combination from all types of devices that can display based on display data written in a frame buffer. The displaying device 24 may be implemented by a monitor, such as a liquid crystal display (LCD) or organic electroluminescence display (OLED). The displaying device 24 may be a head mounted display (HDM). Furthermore, the displaying device 24 may be implemented by a device that can display an image, text information, or the like by projection mapping, a hologram, in air, or the like (may be a vacuum). The displaying devices 24 may be capable of displaying display data in 3D. However, in the present disclosure, the displaying device 24 is not limited thereto.

If the input/output device 23 is a touch panel, the input/output device 23 and displaying device 24 may be arranged to face each other with substantially the same size and shape.

The controlling device 21 has a physically structured circuit in order to perform a function implemented by a code or command included in a program, and for example, is implemented by a data processing device internally provided in hardware.

The controlling device 21 may be a central processing unit, but may also be a microprocessor, processor core, multiprocessor, application-specific integrated circuit (ASIC), or field programmable gate array (FPGA). However, in the present disclosure, the controlling device 21 is not limited thereto.

A storage 28 store various programs and data. The storage 28 is implemented by various storing media such as a hard disk drive (HDD), a solid state drive (SSD), a flash memory, a read only memory (ROM), and the like However, in the present disclosure, storage 28 is not limited thereto.

The terminal 20 stores a program P in the storage 28 and executes the program such that the controlling device 21 executes a process for the parts included in the controlling device 21. Functions performed by the controlling device 21 of the program P stored in the storage 28 are implemented by the terminal 20.

The microphone 24 is used to receive and input audio data. The speaker 26 is used to output audio data. The camera 27 is used to acquire still or moving image data.

### (2) Server HW Configuration

The server 10 is provided with a controlling device 11 (e.g., CPU), a storage 15, a communication interface (I/F) 14, an input/output device 12, and a display 13. Components of the server 10 are mutually connected through a bus B for example.

The controlling device 11 has a physically structured circuit in order to perform a function implemented by a code or command included in a program, and for example, is implemented by a data processing device internally provided in hardware.

The controlling device 11 is typically a central processing unit (CPU), but also may be a microprocessor, processor core, multiprocessor, ASIC, or FPGA. However, in the present disclosure, the controlling device 11 is not limited thereto.

A storage 15 may store various programs and data. The storage 15 is implemented by various storing media such as an HDD, SSD, flash memory, and the like. However, in the present disclosure, storage 15 is not limited thereto.

The communication I/F 14 transmits and receives various data through the network 30. The communication may be performed either by wire or wirelessly, and any communication protocol may be used so long as mutual communication can be performed. The communication I/F 14 may establish a connection between the server 10 and the terminal 20, and perform communication with the terminal 20 through the network 30. The communication I/F 14 transmits various data to the terminal 20 based on instruction from the controlling device 11. Furthermore, the communication I/F 14 receives various data transmitted from the terminal 20 and then transmits to the controlling device 11.

The input/output device 12 is implemented by a device that inputs various operations with regard to the server 10. The input/output device 12 is implemented by any one or a combination from all types of devices that can receiving an input from a user and then transmit information related to the input to the controlling device 11. The input/output device 12 may be implemented by a hardware key represented by a keyboard or the like, or a pointing device such as a mouse or the like. Examples of the input/output device 12 may include a touch panel, camera (operation input through a moving image), and microphone (operation input based on audio). However, in the present disclosure, the input/output device 12 is not limited thereto.

The display 13 may be implemented by a monitor, such as a liquid crystal display (LCD) or an organic electroluminescence display (OLED). The display 13 may be a head mounted display (HDM), and may be capable of displaying display data in 3D. However, in the present disclosure, the display 13 is not limited thereto.

The server 10 stores a program P in the storage 15 and executes the program such that the controlling device 11 executes a process for the parts included in the controlling device 11. Functions performed by the controlling device 11 of the program P stored in the storage 15 are implemented by the server 10.

A hardware configuration of the office server 50C in the POS system 50 may be substantially the same as the hardware configuration of the server 10.

The example embodiments will be described based on the CPU of the terminal 20, the office server 50C in the POS system 50, and/or the server 10 executing the program P.

The controlling device 21 of the terminal 20 and/or the controlling device 11 of the server 10 may perform processes by a physical circuit (hardware) or dedicated circuit formed not only in a CPU but also in an integrated circuit (IC) chip, Large Scale Integration (LSI), and the like. Furthermore, these circuits may be implemented by one or a plurality of integrated circuit, or a plurality of processes indicated in the example embodiments may be implemented by one integrated circuit. Furthermore, LSI may also be referred to as very LSI (VLSI), super LSI, ultra LSI, or the like depending on the degree of integration.

Furthermore, the program P (software program/computer program) of the example embodiments may be provided in a condition stored on a storage medium that can be read by a computer. The recording medium can store a program in a non-transitory storage medium.

Examples of the storage medium may include any one or any combination of a plurality of semiconductor-based or other integrated circuits (IC), such as field programmable gate arrays (FPGA), application-specific ICs (ASIC), and the like, hard disk drives (HDD), hybrid hard drives (HHD), optical discs, optical disk drives (ODD), magneto-optical discs, magneto-optical drives, floppy diskettes, floppy disk drives (FDD), magnetic tapes, solid state drives (SSD), RAM drives, secure digital cards or drives, other arbitrary and suitable recording media, or a combination of two or more thereof. The storage medium, where appropriate, may be volatile, non-volatile, or a combination of volatile and non-volatile. The storage medium is not limited to these examples, and may be any device or medium so long as the program can be stored.

The server 10, the office server 50C in the POS system 50, and/or the terminal 20 may perform functions and operations according to example embodiments by reading the program P stored in the storage medium and then executing the read program P.

Furthermore, the program P of one or more example embodiments may be provided in the server 10, the office server 50C in the POS system 50, and/or the terminal 20 through a transmitting medium (communication network, broadcast waves, or the like) that can transmit the program. The server 10, the office server 50C in the POS system 50, and/or the terminal 20 may perform functions and operations according to example embodiments by executing the program P downloaded via the Internet or the like for example.

Furthermore, the example embodiments can be implemented even in a form of a data signal embedded in a carrier wave, where the program P is achieved by electronic transmission. At least a portion of a process in the server 10, the office server 50C in the POS system 50, and/or the terminal 20 may be implemented by cloud computing configured from one or more computers.

At least a portion of at least one of the terminals 20 and the office server 50C in the POS system 50 may be performed by the server 10. In this case, for example, at least a portion of a process from processes of functional parts of the controlling device 21 of the terminal 20 may be performed by the server 10.

At least a portion of a process in the server 10 may be performed by either one or both of the terminals 20 and the office server 50C in the POS system 50. In this case, for example, at least a portion of a process of the processes of functional parts of the controlling device 11 of the server 10 may be performed by the terminal 20 or the office server 50C in the POS system 50.

The program can be implemented, for example, using ActionScript, JavaScript (registered trademark), and other script languages, Objective-C, Java (registered trademark), and other object-oriented programming languages, HTML and other markup languages, or the like. However, the present disclosure is not limited thereto.

In example embodiments, a number of a barcode for product management conforming to a standard that is widely used in a physical store is assigned to a user of the terminal 20 within a predetermined period for example. Furthermore, a user performing a transaction is distinguished from a number of a barcode included in data of the transaction in a physical store. Thereby, information of a user performing a transaction in a physical store can be relatively easily acquired.

### Functional Configuration

As illustrated in FIG. 1, the server 10 has an assigner 111, converter 112, determiner 113, display controller 114, and communicator 115 as functions or software modules implemented by the controlling device 11.

The assigner 111 assigns a number of a barcode of a predetermined standard for product management, which includes an identification (ID) of a business operator supplying a product and an ID of the product, to a user of the terminal 20. The barcode assigned to the user of the terminal 20 may be valid only for a predetermined period. When the assigner 111 assigns the barcode, the server 10 may set a predetermined period so that the barcode expires after the predetermined time. The assigner 111 stores a user ID of the user of the terminal 20, an assigned number, and the like as user management data 152.

The converter 112 converts a number of one barcode, among a number of barcodes included in transaction data received from the POS system 50, into a user ID of the user of the terminal 20, based on the user management data 152.

The determiner 113 applies a predetermined reward based on a transacted amount, a transacted store, a transacted business operator, or the like included in the transaction data received from the POS system 50 to the user according to the user ID converted by the converter 112.

The display controller 114 controls display of a screen of the terminal 20 based on a process by the assigner 111 or the like.

The communicator 115 performs communication with the terminal 20 and the office server 50C of the POS system 50.

Furthermore, various data such as barcode management data 151, user management data 152, rewards data 153, and the like are stored in the storage 15.

### Process

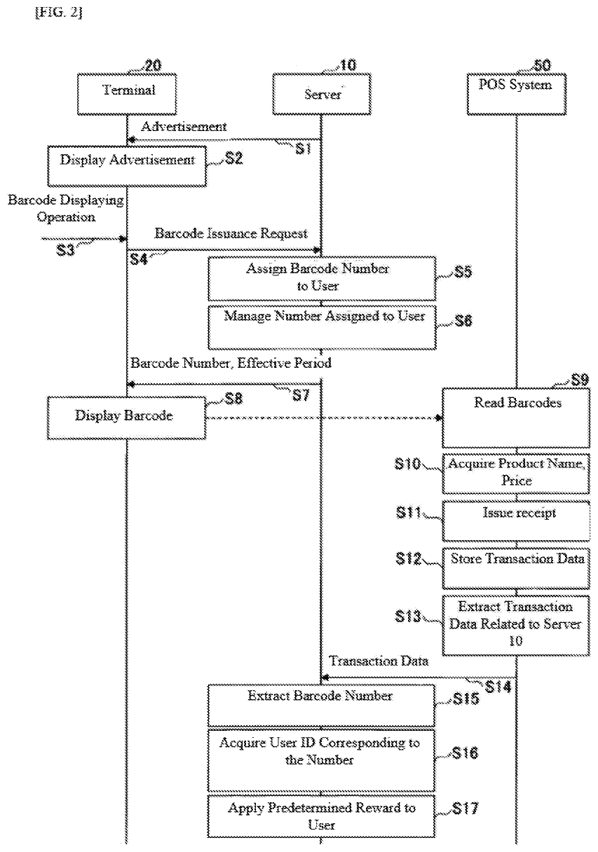

Next, a process of the communication system 1 according to an example embodiment will be described with reference to FIG. 2. FIG. 2 is a diagram showing an example of a processing sequence of the communication system 1 according to an example embodiments.

In operation S1, the server 10 distributes an advertisement related to a physical store to the terminal 20 using an instant messaging service of an SNS provided by the server 10 for example. Herein, the advertisement may include information such as a name of a company holding a campaign or a promotion, a name of a physical store, a campaign/promotion-target product, and the like. Furthermore, the advertisement may be distributed to only the terminal 20 of a user satisfying predetermined conditions. In this case, the server 10 may distribute the advertisement only to a user having an account for a settlement service provided by the server 10 for example.

Next, the terminal 20 displays the distribute advertisement on the screen in operation S2. The user of the terminal 20 receives contents of the advertisement, moves to a physical store, picks up a campaign/promotion-target product, places the product in a shopping cart, and takes the product to a location where the register 50B is installed.

Next, when the terminal 20 receives a barcode display operation from the user in operation S3, the terminal 20 transmits a barcode issue request to the server 10 in operation S4.

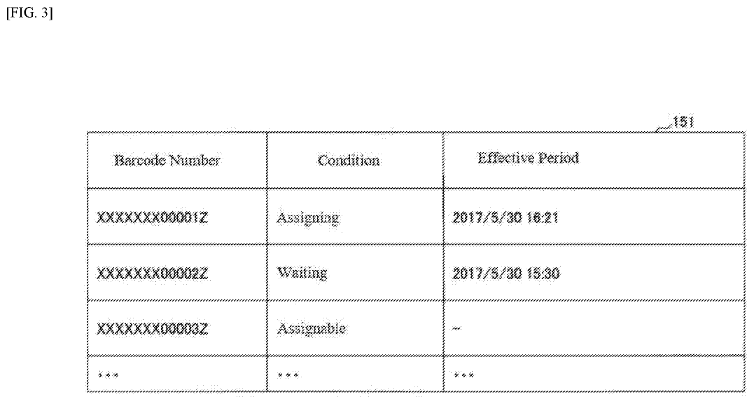

Next, the server 10 assigns a number of a barcode corresponding to the user to the user of the terminal 20 which is valid for a predetermined effective period. FIG. 3 is a diagram showing an example of the barcode management data 151. A condition and an effective period corresponding to the barcode number are stored in the barcode management data 151.

The barcode number is, for example, a product identification number indicating which product of which business operator conforms to an international barcode standard. The international barcode standard may be, for example, a Japanese Article Number (JAN) code, an European Article Number (EAN) code, a Universal Product Code (UPC) code, or the like. In the case of a JAN code, 100,000 numbers can be used per one business operator. In this case, the business operator operating the server 10 acquires a business operator code (e.g., GS1 code that has been issued to the business operator) from an organization that manages the JAN code in advance.

A condition is a condition of assignment with regard to the barcode number, and include conditions such as “assigning”, “waiting”, and “assignable”. “Assigning” indicates that the number is being assigned to a predetermined user. “Waiting” indicates a condition where the number is in a predetermined waiting period after the effective period of the assignment, and the number cannot be assigned to another user. “Assignable” indicates a condition where the server 10 can assign the number to a user.

The effective period is an effective period of a barcode assigned to a user by the server 10. If the effective period has passed, the terminal 20 may not display the barcode. Furthermore, if the effective period has passed, the terminal 20 may display that a received barcode cannot be used. Thereby, communication using a barcode with an effective period that has passed can be reduced, and therefore, a load on the server 10 and the POS system 50 can be reduced.

A predetermined waiting period until the condition is changed (transitioned) from the “waiting” condition to the “assignable” condition may be set in advance by an administrator of the server 10. Alternatively, for example, the server 10 may automatically determine based on a barcode issuance frequency in the server 10 and quantity of barcode numbers managed in the barcode management data 151. In this case, for example, the server 10 may determine that the waiting period is one hour if the server 10 has 50,000 issuance frequencies per hour during the busiest time when the amount of barcode issuance frequencies is at the highest based statistical data, and if the quantity of barcode numbers managed in the barcode management data 151 is 100,000. Alternatively, for example, if the barcode issuance frequency is higher than a threshold frequency due to distribution of an advertisement, and an abundance of deals, promotions, or the like, either one or both of an effective period of a barcode issued after a next time and the waiting period as the barcode issuance frequency increases. The effective period may be expressed as an expiration date and time as shown in the barcode management data 151.

By setting a waiting period, even after the effective period has expired, if a barcode is used during the waiting period after the effective period, a user assigned the barcode can be appropriately specified. Thereby, for example, even when an expired barcode is not deleted by the terminal 20 due to a clock shift in the terminal 20 or the like, or even when the expired barcode is read in the POS system 50, and then a transaction is not completed within an effective period due to reading a barcode of another product or the like, a user using the barcode can be appropriately specified.

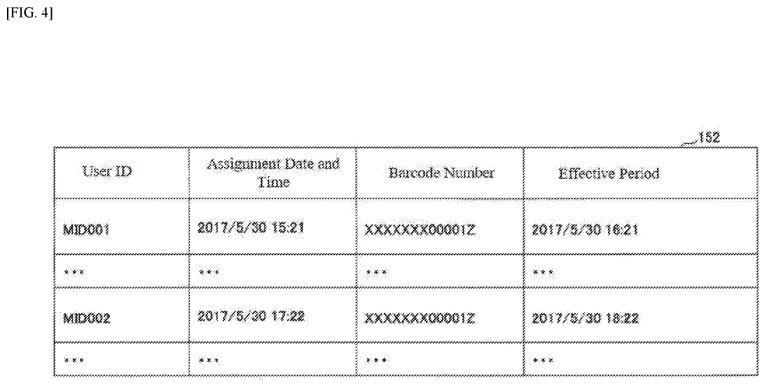

Next, the server 10 stores information of the assigned barcode corresponding to the user ID of the user of the terminal 20 in the user management data 152, in operation S6. FIG. 4 is a diagram showing an example of the user management data 152. The barcode number and effective period corresponding to a user ID and assignment date and time are stored in the user management data 152. The user ID is identification information of the user of the terminal 20. The user ID, for example, may be an ID of the terminal 20, a telephone number of the terminal 20, an account ID assigned to the user for SNS, or the like. The assignment date and time is a time when the server 10 assigned a barcode number to the user. The barcode number is a barcode number assigned to a user by the server 10. The effective period is an effective period of a barcode assigned to a user by the server 10.

Next, the server 10 transmits the assigned barcode number and effective period of the barcode to the terminal 20, in operation S7.

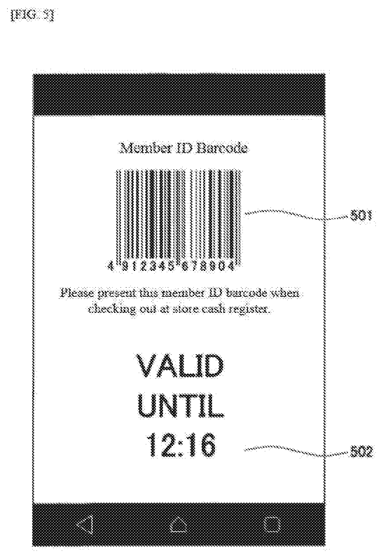

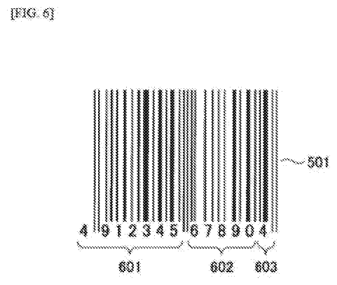

Next, the terminal 20 displays the received barcode number, a barcode based on the number (e.g., a linear or one-dimensional (1D) barcode having parallel lines, matrix codes or two-dimensional (2D) barcode using rectangles, dots, hexagons and other geometric patterns, a quick response (QR) code), and an effective period (or an expiration date and time) of the barcode on the screen, in operation S8. FIG. 5 is a diagram illustrating an example of a display screen of a barcode and an effective period on the terminal 20. In the example in FIG. 5, a barcode is displayed in a region 501, and an effective period (or an expiration date and time) is displayed in region 502. FIG. 6 is a diagram describing an example of a barcode displayed on the terminal 20. In FIG. 6, an example of a JAN code is illustrated. In the JAN code, a first 7-digit number 601 is a number indicating a company, and a subsequent 5-digit number 602 is a number indicating a product. The final single-digit number 603 is a check digit that may be calculated from all the other numbers in the barcode and may be used to confirm the integrity of the barcode. For example, the check digit may be used to confirm whether or not the barcode is correctly read. For the effective period displayed in region 502, a remaining time until the effective period expires may be displayed instead of a total amount of time given for the effective period.

The POS system 50 scans or reads a barcode displayed on the terminal 20 using the barcode reader 50A, in operation S9.

The POS system 50 refers to product management data 511 and acquires a product name and a price corresponding to the read barcode number, in operation S10.

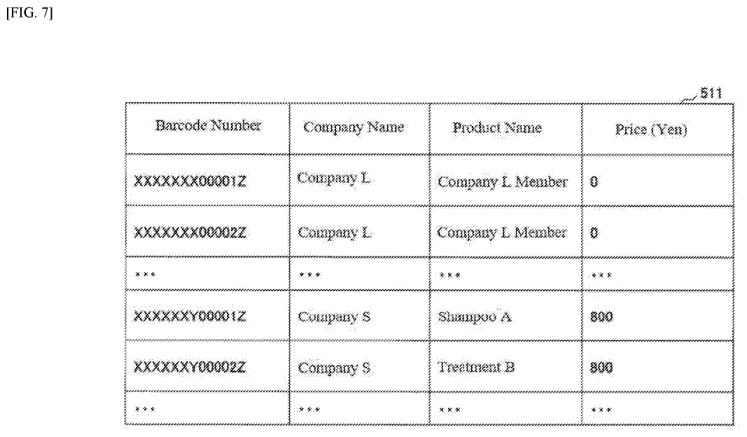

FIG. 7 is a diagram showing an example of the product management data 511. A company name, a product name, and a price corresponding to a barcode number are stored in the product management data 511. The company name, for example, is a name of a company indicated by a first 7-digit number of a JAN code. The product name, for example, is a name of a product indicated by a 5-digit number following the first 7-digit number of the JAN code. The price is a price of the product. In the example in FIG. 7, a price is set as 0 yen (no cost) in a barcode number managed by the barcode management data 151 used by a business operator operating the server 10. Thereby, even when a barcode issued by the server 10 to a user is read, there is no charge by the register 50B for the barcode.

Note that the POS system 50 also reads a barcode and acquires a product name and a price based on the read barcode for physical products brought to the register 50B by the user of the terminal 20. A barcode displayed on the terminal 20 and barcodes of physical products may be read in any order.

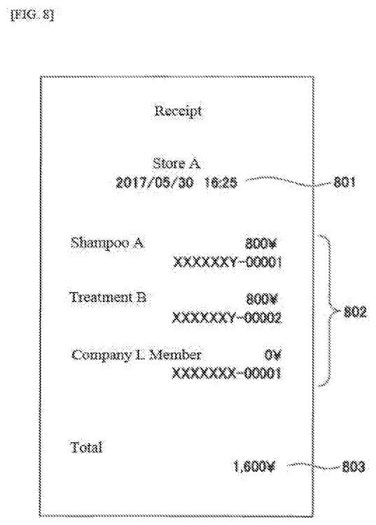

Next, when a payment is completed by the user of the terminal 20, the POS system 50 issues a receipt where at least a portion of transaction contents are printed based on transaction data described later by an operation of a store clerk , in operation S11. FIG. 8 is a diagram illustrating an example of a receipt. In the example in FIG. 8, a date and time (transaction date and time) 801 issued by the receipt, a product name, a price, and a barcode number 802 corresponding to the barcode read by the register 50B, and a total amount 803 are printed.

Next, the POS system 50 stores transaction data indicating transaction contents in the sales management data 512, in operation S12).

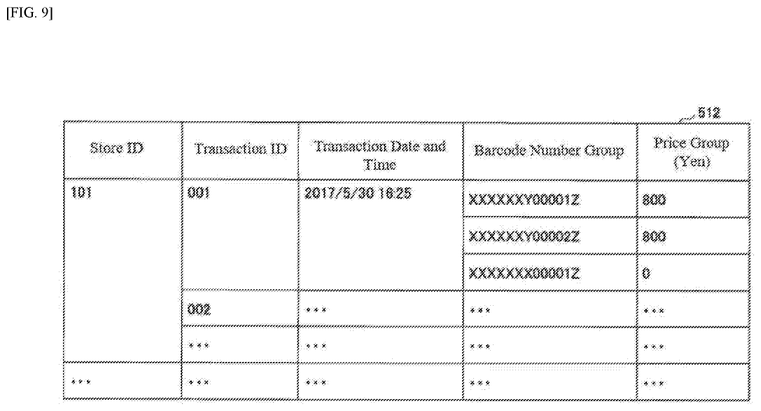

FIG. 9 is a diagram showing an example of the sales management data 512. Transaction data is stored in the sales management data 512. The transaction data includes, for example, a transaction data and time, a barcode number group, a money amount group, and other items corresponding to a store ID and a transaction ID.

The store ID is identification information of a physical store performing a transaction. Transaction ID is identification information for a transaction, and for example, is identification information for each payment in the register 50B. The barcode number group and a money amount group are a barcode number and a money amount of transacted products.

Next, the POS system 50 extracts a transaction containing a barcode number managed by the server 10 from the sales management data 512, in operation S13. In the example of the sales management data 512 in FIG. 9, a transaction 621 containing a barcode number, which is a first 7-digit number “XXXXXXX” of the JAN code, is extracted from the barcode number group. The transaction data includes a transaction data and time, a barcode number group, and a money amount corresponding to a store ID and a transaction ID.

The POS system 50 transmits an ID of a business operator operating the POS system 50 and the extracted transaction data to the server 10, in operation S14.

The server 10 extracts a number that matches a barcode number managed by the server 10 of the barcode numbers includes in the received transaction data, in operation S15.

Next, the server 10 refers to the user management data 152 and acquires a barcode number and user ID based on a transaction date and time, in operation S16. Herein, for example, the server 10 may acquire a user ID corresponding to a barcode number included in the received transaction data during an assignment invalid period, which corresponds to a predetermined waiting period added to the effective period from the assignment date and time. The assignment invalid period may start from the end of the effective period and ends at an assignment invalid time on an assignment invalid date. In this case, when the transaction data 621 exemplified in FIG. 9 is received, the transaction date and time is “2017/5/30 16:25”. In the example of the user management data 152 in FIG. 4, the assignment date and time with regard to a user ID of “MID001” is “2017/5/30 15:21”, and the effective period (the expiration date of the effective period) is “2017/5/30 16:21”. Herein, if the predetermined waiting period is set to 1 hour, the assignment invalid date and time is set to “2017/5/30 17:21”. In other words, in this case, the number is not assigned to another user until “2017/5/30 17:21”, and therefore, user ID “MID001” is acquired.

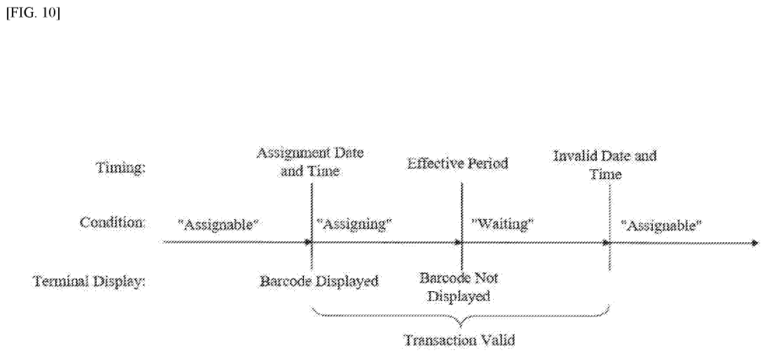

FIG. 10 is a diagram describing an example of a condition based on timings of a barcode number and the like. As described above, when the server 10 assigns a number in an “assignable” condition to a user using the barcode management data 151, an effective period is stored corresponding to the number, and the condition of the number is changed to an “assigning” condition. Furthermore, when the effective period has passed, the condition of the number is changed to a “waiting” condition. When the assignment invalid date and time has passed, which is a date and time where a predetermined waiting period is added after the effective period has passed, the condition of the number is changed to an “assignable” condition. When a number is assigned to a user, the terminal 20 displays a barcode on the screen. When the effective period has passed, the barcode is not displayed. Furthermore, use of the number by the POS system 50 may be treated as valid by the server 10 from the assignment date and time where the number is assigned to the user to the assignment invalid date and time. One barcode is dynamically assigned in this manner, and therefore, an issuance amount of a barcode can be reduced.

Next, the server 10 refers to the rewards data 153 and then applies a predetermined reward based on the transaction data to the user related to the user ID, in operation S17.

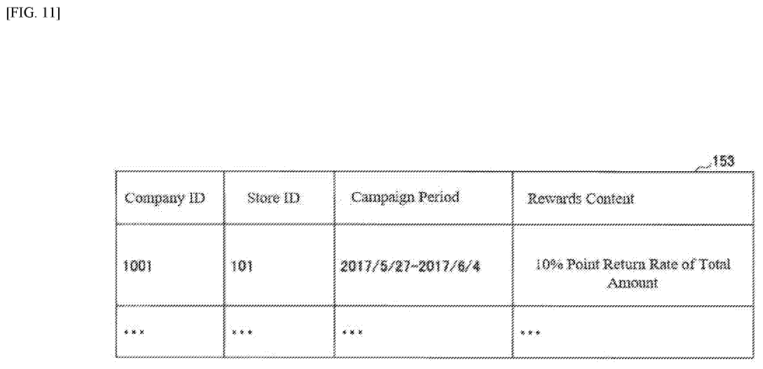

FIG. 11 is a diagram showing an example of the rewards data 153. A company ID, a store ID, a campaign/promotion period, a promotion expiration date, and rewards contents are stored in the rewards data 153. The rewards data 153, for example, may be preset based on a request from a business operator operating the POS system 50, which is a business partner to the business operator operating the server 10. The company ID is an ID of a business operator operating the POS system 50. The rewards content is information indicating contents of a reward applied to a user if the transaction date and time is within a promotion period. In the example in FIG. 11, when a purchase is made in a store with a store ID “101” within a predetermined promotion period, points having a value of 10% of the total amount are applied to the user (e.g., the user account or the user ID). The points, for example, may be used for payments of contents such as stamps of the like that can be used on an SNS service provided by the server 10, external shopping sites affiliated with the business operator of the server 10, products in a physical store, and the like.

In this case, a business operator operating a physical store may pay a predetermined remuneration as an advertising fee or referral fee based on the purchase amount or the like of a user purchasing a product or the like at the physical store due to an advertisement distributed from the server 10, to the business operator operating the server 10. The business operator operating the server 10 may return a portion of the remuneration to the user as points.

A predetermined reward may be set for each promotion-target product as rewards content. In this case, the server 10 may set the rewards content corresponding to a barcode number indicating a promotion-target product in the rewards data 153 shown in FIG. 11, and apply a reward based on the cost of the product included in the transaction data.

In related art systems, there is a problem it is difficult to anticipate how much an advertisement for a certain product and a certain retail store would affect the increase of transactions at the retail store.

According to an example embodiment, volume of transactions occurring in a physical store can be measured based on a standard-complaint barcode assigned to each user or customer receiving an advertisement about the physical store (or products of the physical store), time and effort required to manage and repair a POS system may be reduced.

According to the present disclosure, a number of a barcode for product management conforming to a standard that is widely used in a physical store (e.g., an offline retail store) is assigned to a user of a terminal 20 within a predetermined period for example. Furthermore, a user performing a transaction is distinguished from a number of a barcode included in data of the transaction in a physical store. Thereby, information of a user performing a transaction in a physical store can be relatively easily acquired.

While not restricted thereto, an example embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an example embodiment may be written as a computer program transmitted over a computer-readable transmission medium, such as a carrier wave, and received and implemented in general-use or special-purpose digital computers that execute the programs. Moreover, it is understood that in example embodiments, one or more units of the above-described apparatuses and devices can include circuitry, a processor, a microprocessor, etc., and may execute a computer program stored in a computer-readable medium.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An information processing method comprising:
assigning a barcode to a user of a terminal, the barcode including information for identifying a business operator supplying a product and information for identifying the product;
storing user identification information of the user and the assigned barcode in association with each other;
transmitting the assigned barcode to the terminal;
receiving transaction data including a plurality of barcodes that are read by a barcode reader; and
converting one of the plurality of barcodes included in the transaction data into the user identification information based on the stored assigned barcode.

2. The information processing method according to claim 1, wherein the assigned barcode complies with a predetermined standard for product management, and
wherein the predetermined standard is a Japanese Article Number (JAN) code, an European Article Number (EAN) code, or a Universal Product Code (UPC) code.

3. The information processing method according to claim 1, wherein the receiving the transaction data comprises:
receiving, from a point of sales (POS) system reading one of the plurality of barcodes that is displayed on the terminal, the transaction data indicating that a unit price of the product corresponding to the assigned barcode is calculated to be zero, based on the assigned barcode.

4. The information processing method according to claim 1, further comprising providing a predetermined reward based on at least one of a transacted amount, a transacted store, and a transacted business operator included in the transaction data to the user.

5. The information processing method according to claim 1, wherein the assigning comprises assigning the barcode to the user only for a predetermined period of time;
the storing comprises storing the user identification information, the assigned barcode, and the predetermined period of time in association with each other;
the receiving comprises receiving the transaction data indicating information of a transacted product and a transacted date and time; and
the converting comprises converting the one of the plurality of barcodes indicating the transacted product, into the user identification information, based on the stored assigned barcode.

6. The information processing method according to claim 5, wherein the assigning further comprises determining the predetermined period of time based on a barcode assignment frequency.

7. An information processing device comprising:
a storage configured to store instructions; and
a processor configured to execute the instructions to:
assign a barcode to a user of a terminal, the barcode including information for identifying a business operator supplying product and information for identifying the product;
store user identification information of the user and the assigned barcode in association with each other;
transmit the assigned barcode to the terminal;
receive transaction data including a plurality of barcodes that are read by a barcode reader; and
convert one of the plurality of barcodes included in the transaction data into the user identification information based on the stored assigned barcode.

8. The information processing device of claim 7, wherein the assigned barcode complies with a predetermined standard for product management, and
wherein the predetermined standard is a Japanese Article Number (JAN) code, an European Article Number (EAN) code, or a Universal Product Code (UPC) code.

9. The information processing device of claim 7, wherein the processor is further configured to execute the instructions to:
receive, from a Point of Sales (POS) system reading the one of the plurality of barcodes that is displayed on the terminal, the transaction data indicating that a unit price of the product corresponding to the assigned barcode is calculated to be zero, based on the assigned barcode.

10. The information processing device of claim 7, wherein the processor is further configured to execute the instructions to:
provide a predetermined reward based on at least one of a transacted amount, a transacted store, and a transacted business operator included in the transaction data to the user.

11. The information processing device of claim 7, wherein the processor is further configured to execute the instructions to:
set an effective period of time for the assigned barcode; and
cause the assigned barcode to expire after the effective period of time.

12. The information processing device of claim 11, wherein the processor is further configured to execute the instructions to:
set the effective period of time based on a barcode assignment frequency.

13. A non-transitory computer-readable storage medium storing a program that is executable by a computer to perform the information processing method of claim 1.

14. A communication system comprising an information processing device, a terminal and a Point of Sales (POS) system,
wherein the information processing device comprises:
a storage configured to store instructions; and
a processor configured to execute the instructions to:
assign a barcode to a user of the terminal, the barcode including information for identifying a business operator supplying a product and information for identifying the product;
store user identification information of the user and the assigned barcode in associated with each other;
transmit the assigned number to the terminal;
receive transaction data including a plurality of barcodes that are read by a barcode reader; and
convert one of the plurality of barcodes included in the transaction data into the user identification information based on the stored assigned barcode;
wherein the terminal is configured to display the one of the plurality of barcodes that corresponds to the assigned barcode that is assigned by the information processing device; and
wherein the POS system configured to read the one of the plurality of barcodes that is displayed on the terminal and barcodes of each product using the barcode reader, and transmit the transaction data including the read one of the plurality of barcodes and the barcodes of each product to the information processing device.
